(19) United States
(12) Patent Application Publication
(10) Pub. No.: US 2026/0246865 A1
(43) Pub. Date: Aug. 20, 2026

(54) HANDS-FREE DEVICE FOR VEHICLES AND METHOD OF CONTROLLING THE SAME

(71) Applicants: Hyundai Motor Company, Seoul (KR); Kia Corporation, Seoul (KR)

(72) Inventor: Hyun Woo LEE, Hwaseong-si (KR)

(73) Assignees: Hyundai Motor Company, Seoul (KR); Kia Corporation, Seoul (KR)

(21) Appl. No.: 19/393,401

(22) Filed: Nov. 18, 2025

(30) Foreign Application Priority Data
Feb. 18, 2025 (KR) 10-2025-0020789

(51) Int. Cl. H04M 1/656; H04M 1/60

(52) U.S. Cl. CPC H04M 1/656; H04M 1/6075; H04M 2201/42

(57) ABSTRACT

In a hands-free device for vehicles and a method for controlling the same, the hands-free device includes: a communication unit disposed in a vehicle and communicating with a first mobile terminal; and a processor requesting the first mobile terminal to record call audio of a user during a call in a hands-free mode based on whether the first mobile terminal supports automatic call recording.

### CROSS-REFERENCE TO RELATED APPLICATION

The present application claims priority to and the benefit of Korean Patent Application No. 10-2025-0020789, filed on Feb 18, 2025, the present disclosure of which is incorporated herein by reference in its entirety.

### BACKGROUND

### Field of the Present Disclosure

The present disclosure relates to a hands-free device for vehicles and a method for controlling the same, and more particularly, to a hands-free device for vehicles configured for recording the contents of a call on a mobile terminal in a hands-free mode and a method for controlling the same.

### Discussion of Related Art

A hands-free device for vehicles is a system that connects a driver’s mobile terminal to an infotainment system of a vehicle to enable communication so that phone calls can be made. The driver may receive or originate calls using voice commands or a vehicle display. This system helps reduce the use of drivers' hands when making or receiving calls, thereby preventing accidents and enhancing driving safety.

When making a phone call using the hands-free device for vehicles, a situation where the contents of calls need to be stored occurs. Generally, the contents of calls are directly recorded in the vehicle to generate a call recording file, and then the generated call recording file is transmitted to the mobile terminal. However, this requires a separate memory for storing the call recording file in the vehicle, and an additional protocol to transmit communication files is also required to be designed.

Furthermore, most mobile terminals are equipped with a default recording application (app) developed and provided by mobile terminal manufacturers, but a new recording app is required to transmit and manage call recording files generated by the hands-free device. For example, the driver needs to check data recorded using the driver’s mobile terminal through the default recording app, and check data recorded using the hands-free device for the vehicle through the new recording app. That is, integrated management of the default recording app and the new recording app is not possible.

### BRIEF SUMMARY

The various aspects of the present disclosure are directed to providing a vehicle hands-free device and a method for controlling the same, which are configured for recording, storing, and managing call contents conducted through the hands-free device by using a default recording application disposed on a mobile terminal.

Technical objects to be achieved by the present disclosure are not limited to that described above, and other technical objects that have not been described will be clearly understood by those skilled in the technical field of the present disclosure to which the present disclosure pertains from the following description.

According to various aspects of the present disclosure, there is provided a hands-free device for vehicles, the hands-free device including: a communication unit disposed in a vehicle and communicating with a first mobile terminal; and a processor requesting the first mobile terminal to record call audio of a user during a call in a hands-free mode based on whether the first mobile terminal supports automatic call recording.

According to various aspects of the present disclosure, the processor may be configured to: based on a connection for hands-free communication with the first mobile terminal is completed, confirm whether the first mobile terminal supports call recording; confirm a setting state of detailed options for automatic call recording based on a result of the confirmation indicates that the first mobile terminal supports the automatic call recording; and determine whether to request the first mobile terminal to automatically record the call audio of the user based on the setting state of the detailed options.

Based on that a call channel is connected in the hands-free mode, the processor may request the first mobile terminal to perform automatic call recording based on a first option for automatically recording all calls is set as the setting state of the detailed options.

Based on that a call is received from a second mobile terminal and a call channel is connected in the hands-free mode, the processor may display a first user interface (UI) screen including call reception information related to the second mobile terminal, a call acceptance menu, and a menu for requesting call recording based on the call is accepted on a display unit based on a second option for deactivating automatic recording of all calls is set as the setting state of the detailed options.

Based on that call acceptance and call recording are requested by the user through the first UI screen, the processor may request the first mobile terminal to start call recording.

Based on that a call channel is connected in the hands-free mode, the processor may display a second UI screen including a menu for requesting in-call recording based on a second option for deactivating automatic recording of all calls is set as the setting state of the detailed options on a display unit.

Based on that recording is requested by the user during a call through the second UI screen, the processor may request the first mobile terminal to start call recording.

Based on that a call channel is connected in the hands-free mode, the processor may request the first mobile terminal to perform automatic call recording based on it is confirmed that a third option for automatically recording only calls via a current vehicle is set as the setting state of the detailed options, and based on that the first mobile terminal supports the automatic call recording but an automatic call recording function is off, the first mobile terminal may initiate the automatic call recording based on the automatic call recording request is received.

Based on that a call is received from a second mobile terminal and a call channel is connected in the hands-free mode, the processor may display a first UI screen including call reception information related to the second mobile terminal, a call acceptance menu, and a menu for requesting call recording when a call is accepted on a display unit, based on that the first mobile terminal supports recording but does not support automatic call recording.

Based on that call acceptance and call recording are requested by the user through the first UI screen, the processor may request the first mobile terminal to start call recording.

Based on that a call is initiated with the call acceptance, the processor may display a second UI screen including a menu for requesting in-call recording on the display unit.

Based on that recording is requested by the user during the call through the second UI screen, the processor may request the first mobile terminal to start call recording.

According to various aspects of the present disclosure, there is provided a method for controlling a hands-free device for vehicles including one or more memories and at least one processor, the method including: connecting the hands-free device to a first mobile terminal to enable wireless communication and switching the hands-free device to a hands-free mode; and requesting the first mobile terminal to record call audio of a user during a call in the hands-free mode based on whether the first mobile terminal supports automatic call recording.

The method may further comprise, after the switching, confirming whether the first mobile terminal supports call recording; and confirming a setting state of detailed options for automatic call recording based on a result of the confirming indicates that the first mobile terminal supports the automatic call recording, In the operation of requesting the first mobile terminal, a determination may be made as to whether to request the first mobile terminal to automatically record the call audio of the user based on the confirmed setting state of the detailed options.

In the operation of requesting the first mobile terminal, based on that a call channel is connected in the hands-free mode, the first mobile terminal may be requested to perform automatic call recording based on it is confirmed that a first option for automatically recording all calls is set as the setting state of the detailed options.

In the operation of requesting the first mobile terminal, based on that a call is received from a second mobile terminal and a call channel is connected in the hands-free mode, a first UI screen including call reception information related to the second mobile terminal, a call acceptance menu, and a menu for requesting call recording based on the call is accepted may be displayed based on a second option for deactivating automatic recording of all calls is set as the setting state of the detailed options.

In the operation of requesting the first mobile terminal, based on that call acceptance and call recording are requested by the user through the first UI screen, the first mobile terminal may be requested to start call recording.

In the operation of requesting the first mobile terminal, based on that a call channel is connected in the hands-free mode, a second UI screen including a menu for requesting in-call recording may be displayed based on a second option for deactivating automatic recording of all calls is set as the setting state of the detailed options.

In the operation of requesting the first mobile terminal, based on that recording is requested by the user during the call through the second UI screen, the first mobile terminal may be requested to start call recording.

In the operation of requesting the first mobile terminal, based on that a call channel is connected in the hands-free mode, the first mobile terminal is requested to perform automatic call recording based on it is confirmed that a third option for automatically recording only calls via a current vehicle may be set as the setting state of the detailed options, and based on that the first mobile terminal supports automatic call recording but an automatic call recording function is off, the first mobile terminal may initiate automatic call recording based on the automatic call recording request is received.

In the operation of requesting the first mobile terminal, based on that a call is received from a second mobile terminal and a call channel is connected in the hands-free mode, a first UI screen including call reception information related to the second mobile terminal, a call acceptance menu, and a menu for requesting call recording when a call is accepted may be displayed on a display unit based on that the first mobile terminal supports recording but does not support automatic call recording.

In the operation of requesting the first mobile terminal, based on that call acceptance and call recording are requested by the user through the first UI screen, the first mobile terminal may be requested to start call recording.

In the operation of requesting the first mobile terminal, based on that a call is initiated with the call acceptance, a second UI screen including a menu for requesting in-call recording may be displayed on the display unit.

In the operation of requesting the first mobile terminal, based on that recording is requested by the user during the call through the second UI screen, the first mobile terminal may be requested to start call recording.

According to various aspects of the present disclosure, it is possible to automatically record call audio when a user makes a call using a vehicle hands-free function by maintaining and utilizing a call recording function of a mobile terminal. The user may improve convenience by setting the mobile terminal to automatically record call audio during hands-free communication or to record only desired calls.

Furthermore, settings related to call recording may be shared between the vehicle hands-free device and the mobile terminal, and the hands-free device may directly display, on a display unit, a menu related to call recording settings of the mobile terminal so that the user can control the settings.

Furthermore, the user may maintain a system environment of an existing recording application disposed on the mobile terminal as it is, while retrieving or managing call recording files recorded through the vehicle, thereby eliminating the need to install a separate recording application on the mobile terminal for call recording.

Furthermore, since the vehicle utilizes the call recording environment already implemented in the mobile terminal, it is possible to provide a call recording function without separately installing a recording function in a vehicle infotainment system.

Effects that can be obtained from the present disclosure are not limited to that described above, and other effects that have not been described will be clearly understood by those skilled in the technical field of the present disclosure to which the present disclosure pertains from the following description.

### BRIEF DESCRIPTION OF THE DRAWINGS

The above and other objects, features and advantages of the present disclosure will become more apparent to those of ordinary skill in the art by describing various aspects thereof in detail with reference to the accompanying drawings, in which:

FIG. 1 is a view exemplarily illustrating a head unit of a vehicle and a first mobile terminal according to various exemplary embodiments of the present disclosure;

FIG. 2 is a block diagram illustrating a head unit according to various exemplary embodiments of the present disclosure;

FIG. 3 is a block diagram illustrating a hands-free device for vehicles according to various exemplary embodiments of the present disclosure;

FIG. 4 is an exemplary diagram of a detailed options setting screen;

FIG. 5 is an exemplary diagram of a call information screen;

FIG. 6 is an exemplary diagram of an automatic recording screen;

FIG. 7 is an exemplary diagram of a call information screen;

FIG. 8 is an exemplary diagram of a recording request screen;

FIG. 9 is an exemplary diagram showing file names of call recording files stored in the first mobile terminal;

FIG. 10 is a flowchart illustrating the operations of the hands-free device and the first mobile terminal when the hands-free device according to various exemplary embodiments of the present disclosure receives a call;

FIG. 11 is a flowchart illustrating operation S1070 illustrated in FIG. 10 in detail when the hands-free device according to various exemplary embodiments of the present disclosure receives a call.

FIG. 12 is a flowchart illustrating the operations of the hands-free device and the first mobile terminal when the hands-free device according to various exemplary embodiments of the present disclosure originates a call;

FIG. 13 is a flowchart illustrating operation S1270 illustrated in FIG. 12 in detail when the hands-free device according to various exemplary embodiments of the present disclosure originates a call;

FIG. 14 is a flowchart illustrating the operations of the hands-free device and the first mobile terminal when a call is terminated according to various exemplary embodiments of the present disclosure;

FIG. 15 is a flowchart illustrating the operation of the hands-free device of FIG. 14;

FIG. 16 is a flowchart illustrating an operation of recording a call when the first mobile terminal operates in a hands-free mode according to an exemplary embodiment of the present disclosure; and

FIG. 17 is a flowchart illustrating the operation of terminating a call when the first mobile terminal operates in the hands-free mode according to various exemplary embodiments of the present disclosure.

### DETAILED DESCRIPTION OF EXEMPLARY EMBODIMENTS

Hereinafter, various exemplary embodiments of the present disclosure will be described in detail with reference to the accompanying drawings so that those skilled in the art may easily implement the present disclosure. However, the present disclosure may be implemented in various different ways, and is not limited to the exemplary embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless stated otherwise.

In the present disclosure, the terms first, second, etc. are only used to distinguish one element from another and do not limit the order or the degree of importance between the elements unless mentioned. Accordingly, a first element in an exemplary embodiment could be termed a second element in another exemplary embodiment of the present disclosure, and similarly, a second element in an exemplary embodiment could be termed a first element in another exemplary embodiment of the present disclosure, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described In various embodiments do not necessarily mean essential elements, and some of them may be optional elements. Therefore, an exemplary embodiment including a subset of elements described in an exemplary embodiment of the present disclosure is also included in the scope of the present disclosure. In addition, various exemplary embodiments including other elements in addition to the elements described in the various exemplary embodiments of the present disclosure are also included in the scope of the present disclosure.

The advantages and features of the present disclosure and the way of attaining them will become apparent with reference to various exemplary embodiments described below in detail in conjunction with the accompanying drawings. Embodiments, however, may be embodied in many different forms and should not be constructed as being limited to example embodiments set forth herein. Rather, these embodiments are provided so that the present disclosure will be complete and will fully convey the scope of the present disclosure to those skilled in the art.

In the present disclosure, each of phrases such as "A or B", "at least one of A and B", "at least one of A or B", "A, B or C", "at least one of A, B and C", ""at Each of the phrases such as "at least one of A, B or C" and "at least one of A, B, C or combination thereof" may include any one or all possible combinations of the items listed together in the corresponding one of the phrases.

Hereinafter, various exemplary embodiments of the present disclosure will be described with reference to the accompanying drawings.

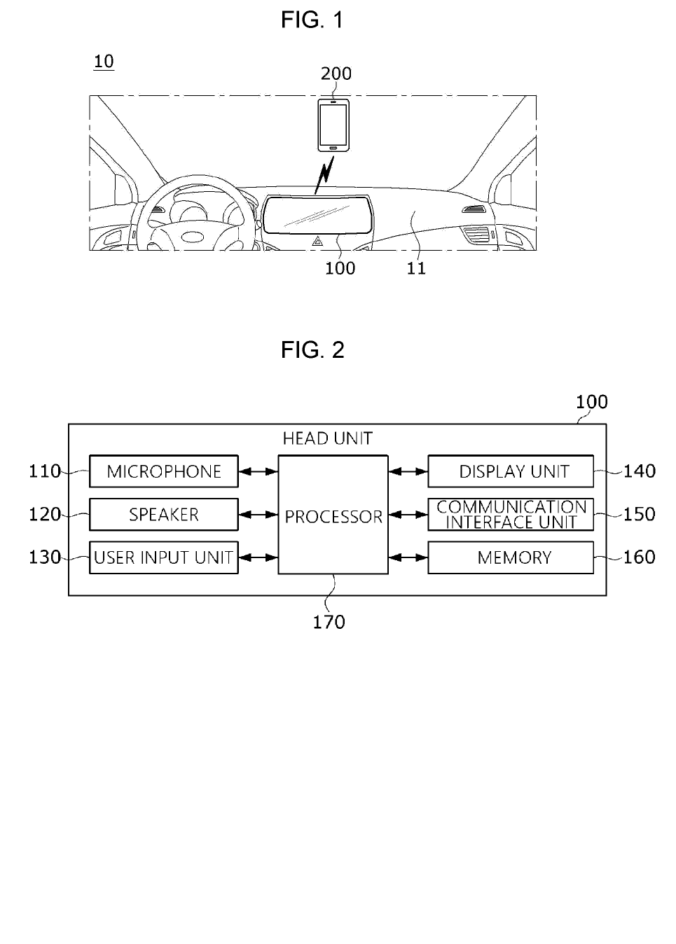

FIG. 1 is a view exemplarily illustrating a head unit 100 of a vehicle 10 and a first mobile terminal 200 according to various exemplary embodiments of the present disclosure.

Referring to FIG. 1, a center fascia may include a number of convenience devices such as a control panel (e.g., a controller for an air conditioner), air vents, a head unit 100, and the like disposed between a driver’s seat and a passenger’s seat on a dashboard 11 of the vehicle 10.

The head unit 100 is a multimedia device disposed in the center fascia of the vehicle 10, and may provide audio/video/navigation functions, telematics functions, or infotainment services. Infotainment services include AM/FM radio, satellite radio, DVDs/CDs, cassette tapes, USB MP3, Global Positioning System (GPS) navigation, and Wi-Fi services, and may also provide state information about the vehicle 10. Furthermore, the head unit 100 may be linked with other systems (e.g., an instrument cluster or a battery management system (BMS)) in the vehicle 10, and may display information received from the other systems. Furthermore, the head unit 100 may be connected to the first mobile terminal 200 to enable wireless communication, thereby providing a hands-free function. The head unit 100 may be, for example, an audio video navigation telematics controller (AVNT) or an audio video navigation (AVN).

FIG. 2 is a block diagram illustrating a head unit 100 according to various exemplary embodiments of the present disclosure.

Referring to FIG. 2, a head unit 100 according to various exemplary embodiments of the present disclosure may include a microphone 110, a speaker 120, a user input unit 130, a display unit 140, a communication interface unit 150, a memory 160, and a processor 170.

The microphone 110 may sense and receive the voice of a user riding in the vehicle 10 and transmit a voice signal corresponding to the input voice to the processor 170. The microphone 110 may be built into the head unit 100, or one or more microphones may be disposed at positions such as the steering wheel, center fascia, headliner, or room mirror.

The speaker 120 may output various types of audio to the outside thereof, may be disposed at one or more positions where audio may be delivered to the user, such as a center fascia, vehicle door, and headrest of the seat, and may include an amplifier. The audio may include sounds generated in a multimedia playback mode, call connection tones generated in a hands-free mode, and call audio from a receiver and a caller.

The user input unit 130 provides an interfacing path between the vehicle 10 and the user, and the user may search for or request a desired function by operating the user input unit 130. For example, the user input unit 130 may select the hands-free mode, set the first mobile terminal 200 to automatically record the contents of calls, or request the first mobile terminal to record the contents of calls during a call.

The user input unit 130 may be disposed in the head unit 100, a region where a gearbox is disposed, or the steering wheel. Furthermore, the user input unit 130 may include hardware devices such as various buttons, switches, pedals, keyboards, mouses, trackballs, various levers, handles, sticks, or the like.

Furthermore, the user input unit 130 may further include a touch screen panel (TSP) forming a layered structure with the display unit 140.

The display unit 140 may display various items of information related to the vehicle 10 and may visually display information processed in the head unit 100. For example, the display unit 140 may display a user interface (UI) screen related to route guidance in a navigation mode, and may display a UI related to a call when operating in a call mode by the hands-free function provided by the head unit 100.

The display unit 140 may be implemented as one of various types of panels, such as a digital light processing (DLP) panel, a plasma display panel (PDP), a liquid crystal display (LCD) panel, an electroluminescence (EL) panel, an electrophoretic display (EPD) panel, an electrochromic display (ECD) panel, a light emitting diode (LED) panel, an organic light emitting diode (OLED) panel, or the like, but this is exemplary, and is not limited thereto.

The communication interface unit 150 may include one or more communication modules that communicate with one or more external devices or one or more external vehicles through a wired or wireless communication network. The wired or wireless communication network may include a wireless local area network (LAN) (WLAN), Wireless Broadband (WiBro), Wireless Fidelity (Wi-Fi), Worldwide Interoperability for Microwave Access (WiMAX), High-Speed Downlink Packet Access (HSDPA), Code Division Multi Access (CDMA), Enhanced Voice-Data Optimized or Enhanced Voice-Data Only (EV-DO), Wideband CDMA (WCDMA), High Speed Uplink Packet Access (HSUPA), 3G, 4G such as Long- Term Evolution (LTE ), and 5G communication networks.

The external devices may provide a number of services related to the vehicle 10, such as controlling various functions of the vehicle 10, managing the state, providing driving assistance, providing connected vehicle services, providing traffic accident analysis services, providing autonomous driving services, and the like. The external vehicles may support manual driving or autonomous driving through vehicle to vehicle (V2V) communication with the vehicle 10. The information received through the communication interface unit 150 may be displayed on the display unit 140 or updated or stored in the memory 160.

Furthermore, the communication interface unit 150 may establish a connection to the first mobile terminal 200 in a communicable state via a short-range communication network and transmit and receive signals. The short-range communication network may be formed by Bluetooth Low Energy (BLE) communication, NFC communication, RFID communication, or UWB communication. For example, when connected by Bluetooth pairing, the head unit 100 may provide a hands-free function to the user. Accordingly, when the communication interface unit 150 is communicatively connected to the first mobile terminal 200, the communication interface unit 150 may request the first mobile terminal 200 to originate a call, connect a communication channel for transmitting and receiving call audio when receiving call reception information from the first mobile terminal 200, and then transmit and receive the call audio (incoming audio and outgoing audio), or transmit and receive audio/video (AV) signals for playing digital content.

Furthermore, the communication interface unit 150 may communicate with other devices (e.g., may devices including an electronic control unit (ECU), external storage media, and the like) in the vehicle 10 through various wired communications such as Controller Area Network (CAN) communication, Local Interconnect Network (LIN) communication, Universal Serial Bus (USB), High Definition Multimedia Interface (HDMI), Digital Visual Interface (DVI), Recommended Standard232 (RS-232), power line communication, Plain Old Telephone Service (POTS), or the like.

The memory 160 may include a volatile memory and/or a non-volatile memory. The memory 160 may store commands or data related to components, one or more programs and/or software, an operating system, and the like to implement and/or provide operations, functions, and the like provided by the head unit 100.

The processor 170 is configured to control the overall operation of the head unit 100 by executing the one or more programs stored in the memory 160. For example, the processor 170 may provide an infotainment service, a navigation service, an audio/video service, a hands-free service of the vehicle 10 based on a user command input from a graphic user interface (GUI) or the user input unit 130, or control vehicle functions related to driving, doors, windows, and a digital key of the vehicle 10.

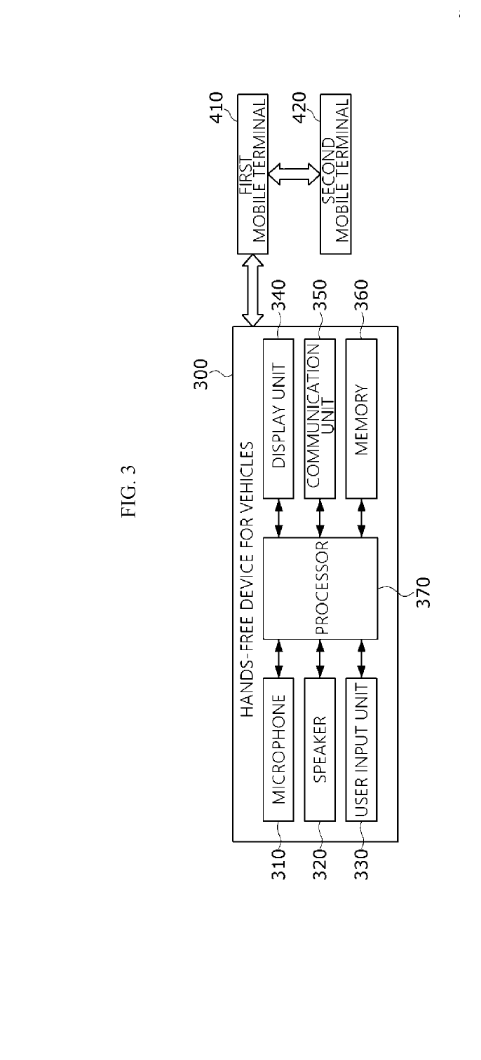

FIG. 3 is a block diagram illustrating a hands-free device 300 for vehicles according to various exemplary embodiments of the present disclosure.

First, a first mobile terminal 410 is a communication-enabled device carried by a user (hereinafter referred to as a “first user”) riding in the vehicle 10, and may include a smartphone, a tablet device, a laptop, or the like. Furthermore, the first mobile terminal 410 may store a digital key to control functions of the vehicle 10 (e.g., door locking and unlocking, remote start, and the like).

Furthermore, the first mobile terminal 410 may operate in a hands-free mode when connected to the hands-free device 300 in a communicable state, and may transmit the voice of the first user received from the hands-free device 300 to a second mobile terminal 420 and transmit the voice of a user (hereinafter referred to as a “second user”) of the second mobile terminal 420 to the hands-free device 300 when the first mobile terminal 410 and a second mobile terminal 420 are connected via a phone call.

Furthermore, the first mobile terminal 410 may make a phone call to the second mobile terminal 420 through one or more call base stations. The first mobile terminal 410 may provide various recording functions according to specifications set at the time of factory shipment or according to updates of programs stored in the first mobile terminal 410.

For example, the first mobile terminal 410 may provide a first recording function that supports recording during a call and also supports automatic recording, or may provide a second recording function that supports recording but does not support automatic recording. Automatic recording is a function that automatically records all calls without asking the first user whenever a call occurs.

Furthermore, when the first mobile terminal 410 provides the first recording function, detailed options of the first recording function may be set or changed at a request from the first user. The detailed options of the first recording function include first, second, and third options, and the first user may select and change the setting state of the detailed options, that is, one of the first, second, and third options, on the first mobile terminal 410 or the hands-free device 300.

The first option is an option for the first mobile terminal 410 to automatically record all calls, that is, an option for activating automatic recording of all calls. Accordingly, when operating in hands-free mode, the first mobile terminal 410 may automatically record and store the voice of the first user input through the microphone 310 of the hands-free device 300 and the voice of the second user received from the second mobile terminal 420.

The second option is an option for deactivating automatic recording of all calls. Accordingly, even when the first mobile terminal 410 supports automatic recording, the first mobile terminal 410 may not perform automatic recording of a call occurring in hands-free mode when the second option is set.

The third option is an option for automatically recording only calls via the vehicle 10 to which a call channel is connected by a short-range communication network such as Bluetooth, that is, an option for activating automatic recording only calls via the present vehicle. For example, the first user may not prefer automatic recording and thus set the second option, but may want to record calls that occur while riding in the vehicle 10. For example, the first user may set the third option to be activated.

The hands-free device 300 may be implemented as some of the components of the head unit 100 described with reference to FIG. 1 and FIG. 2, or may be implemented as a device independent of the head unit 100. The hands-free device 300 is communicably connected to the first mobile terminal 410, transmits and receives AV signals for playing call audio or digital content, and outputs the AV signals through a speaker 320 or a display unit 340 if necessary.

Referring to FIG. 3, the hands-free device 300 according to various exemplary embodiments of the present disclosure may include a microphone 310, the speaker 320, a user input unit 330, the display unit 340, a communication unit 350, a memory 360, and a processor 370.

The microphone 310, the speaker 320, the user input unit 330, the display unit 340, the communication unit 350, the memory 360, and the processor 370 are identical to or similar to the components 110 to 170 of the head unit 100 described with reference to FIG. 1 and FIG. 2, and therefore, a detailed description thereof is omitted.

When the vehicle 10 is started, a Bluetooth module of the hands-free device 300 is also activated and enters a connection standby state, and when the connection is completed, that is, when communicably connected to the first mobile terminal 410, the hands-free device 300 operates in the hands-free mode. The hands-free mode is a mode in which a call channel with the first mobile terminal 410 is formed using the head unit 100 or the hands-free device 300 and call audio or AV signals are input and output. Hereinafter, operations related to receiving or originating a call in the hands-free mode will be described by way of example.

The microphone 310 may receive the voice of the first user in the vehicle 10, process the voice into an analog voice signal, and then transmit the analog voice signal to the processor 370.

The speaker 320 may output the voice of the second user of the second mobile terminal 420 transmitted through the first mobile terminal 410.

The user input unit 330 may receive a first user command and transmit the first user command to the processor 370. The user input unit 330 may be used to select a desired function or change set contents on the UI screen displayed on the display unit 340.

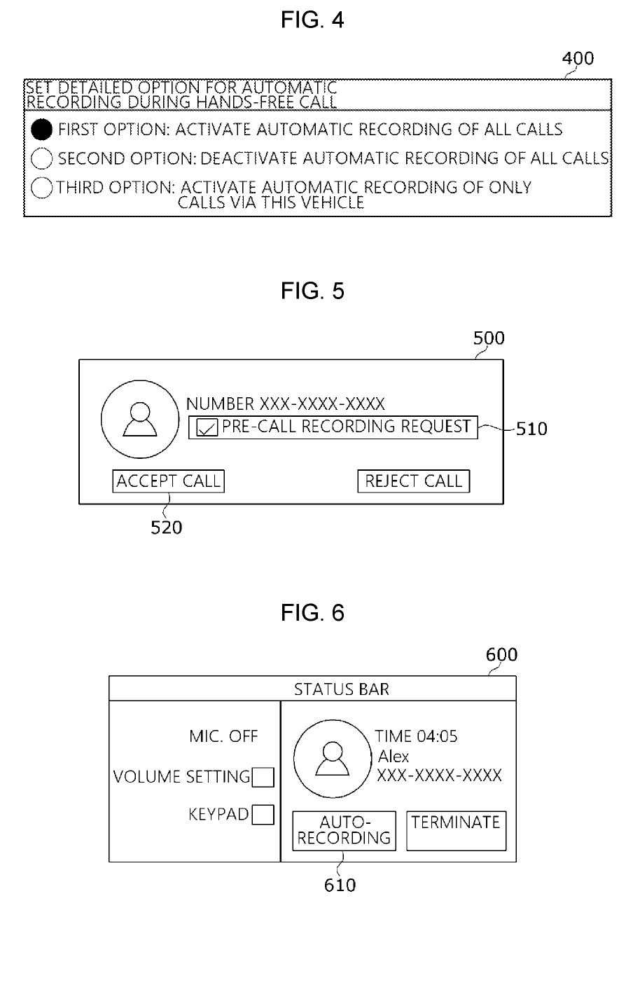

For example, when a detailed option setting screen 400 such as FIG. 4 is displayed, the first user may select a desired detailed option from among the first, second, and third options by operating the user input unit 330. In FIG. 4, the first option is an option for activating recording of all calls, the second option is an option for deactivating automatic recording of all calls, and the third option is an option for automatically recording only calls via the present vehicle.

The display unit 340 may display various UI screens related to automatic recording in the hands-free mode.

The communication unit 350 is connected to the first mobile terminal 410 in a short-range communication method to form a call channel, and may transmit outgoing audio to the first mobile terminal 410 or receive incoming audio from the first mobile terminal 410. An example of the short-range communication method may be Bluetooth communication.

The memory 360 may store at least one program (e.g., operating system, software, firmware, middleware, or application, etc.), various data, and at least one command for controlling the hands-free device 300, thereby making it possible to load a program, read or write data, or perform an operation corresponding to a command at the request of the processor 370.

The processor 370 may perform overall control of the hands-free device 300 according to input commands. The commands may be input to the processor 370 by the user input unit 330, the communication unit 350, or the memory 360. The processor 370 may execute a program or a command stored in the memory 360 to control the operation of other components (hardware or software) and perform signal processing (e.g., various processing operations, including noise removal, control signal transmission, and the like), data processing, or calculation. Furthermore, the processor 370 may load commands or data received from other components into the volatile memory, process the commands or data stored in the volatile memory, and store processing results in the non-volatile memory.

The processor 370 may be implemented by an application specific integrated circuit (ASIC), a digital signal processor (DSP), a digital signal processing device (DSPD), a programmable logic device (PLD), a field programmable gate array (FPGA), a general processor, a controller, a microcontroller, a microprocessor, or the like.

Hereinafter, the operations of the hands-free device 300 and the first mobile terminal 410 in the hands-free mode are described.

When a communication channel with the first mobile terminal 410 is formed through short-range communication (e.g., Bluetooth), the processor 370 may operate in the hands-free mode to output the call audio received from the first mobile terminal 410 to the speaker 320 and process the call audio of the first user received by the microphone 310 to be transmitted to the first mobile terminal 410.

For example, the processor 370 may convert the voice of the second user, that is, the digital signal received from the first mobile terminal 410, into an analog signal and perform signal processing to remove noise. The processor 370 may transmit the voice signal that has been subjected to signal processing to the speaker 320 for output.

Furthermore, the processor 370 may convert the voice of the first user input through the microphone 310, that is, the analog signal, into a digital signal and remove noise. The processor 370 may be configured for controlling the communication unit 350 to transmit the voice signal that has been subjected to signal processing to the first mobile terminal 410.

Furthermore, when the third option is selected in the detailed option setting screen 400 displayed on the display unit 340, the processor 370 may transmit identification information (e.g., Media Access Control (MAC) address) about the Bluetooth module to the first mobile terminal 410 and request the first mobile terminal 410 to record only the call audio made via the Bluetooth module identified by the identification information. Accordingly, the first mobile terminal 410 may store the received identification information and when the third option is set, may perform call recording when a communication channel with the Bluetooth module corresponding to the identification information is formed.

Furthermore, based on whether the first mobile terminal 410 supports automatic call recording, the processor 370 may automatically record call audio of the first user during a call in the hands-free mode, or may request the first mobile terminal 410 to record the call audio from a time point at which a manual instruction is received by the manual instruction from the first user.

To the present end, when the connection for hands-free communication between the communication unit 350 and the first mobile terminal 410 is completed, the processor 370 may confirm whether the first mobile terminal 410 supports one of the first and second recording functions. For example, the processor 370 may confirm whether the first mobile terminal 410 supports the recording functions by querying the first mobile terminal 410.

As a result of the confirmation, when it is confirmed that the first mobile terminal 410 supports recording and automatic call recording, that is, provides the first recording function, the processor 370 may confirm the setting state of detailed options for automatic call recording. The processor 370 may confirm the setting state of detailed options by querying the first mobile terminal 410. The processor 370 may be configured to determine whether to request the first mobile terminal 410 to automatically record the call audio of the first and second users based on the confirmed setting state of the detailed options.

As a result of confirming the setting state of the detailed options, when it is confirmed that the first option for automatically recording all calls is set, the processor 370 may be configured to generate a call information screen 500 as illustrated in FIG. 5 and display the call information screen 500 on the display unit 340 before the call connection is established. The call information screen 500 illustrated in FIG. 5 may include a phone number of the second mobile terminal 420, a name of the second user, a pre-call recording request menu (Start recording by accept this call) 510, a call acceptance menu (Accept) 520, and a call rejection menu (Reject). Since the first option is set, the processor 370 may automatically check a check box in the pre-call recording request menu 510. This allows the first user to be aware that the current call is automatically recorded. Accordingly, when the first user selects the call acceptance menu 520, the processor 370 may request the first mobile terminal 410 to perform automatic recording when a call channel is connected (that is, when the call starts).

Furthermore, the processor 370 may be configured to generate an automatic recording screen 600 as illustrated in FIG. 6 during a hands-free call with the second user of the second mobile terminal 420 and process the automatic recording screen 600 to be displayed on the display unit 340. The automatic recording screen 600 may include the phone number of the second mobile terminal 420, the name or nickname of the second user, a menu (Recording) 610 indicating that the call is being automatically recorded, and a menu (Terminate) requesting the termination of automatic recording.

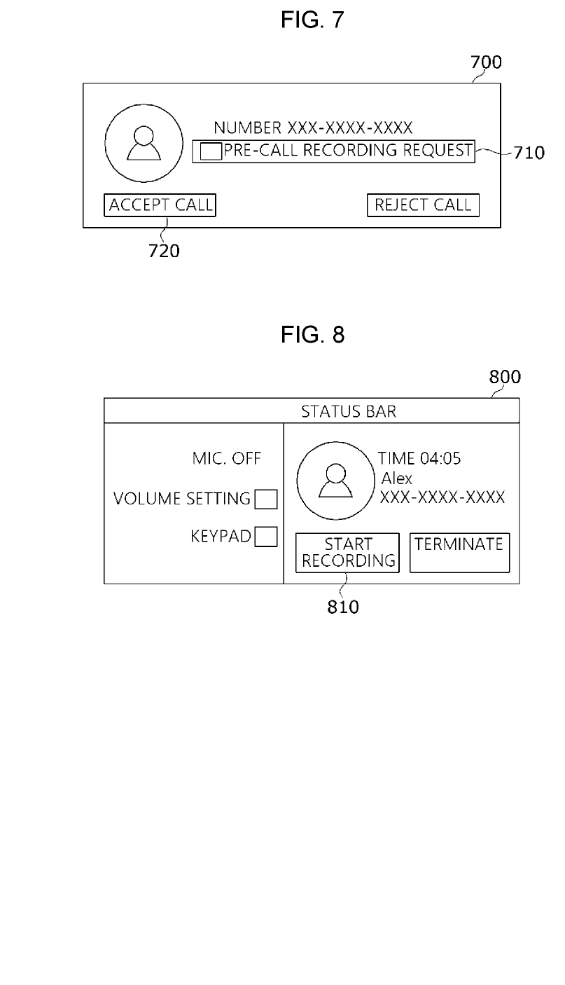

Furthermore, as a result of confirming the setting state of the detailed options, when it is confirmed that the second option for deactivating automatic recording of all calls is set, the processor 370 may be configured to generate a call information screen 700 as illustrated in FIG. 7 and display the call information screen 700 on the display unit 340 before the call connection is established.

The call information screen 700 illustrated in FIG. 7 may include a phone number of the second mobile terminal 420, a name of the second user, a pre-call recording request menu (Start recording by accept this call) 710, a call acceptance menu (Accept) 720, and a call rejection menu (Reject). The menu 710 is a menu for manually requesting automatic recording of a call when the call is accepted.

When the first user checks the check box of the pre-call recording request menu 710 and selects the call acceptance menu 720, the processor 370 may request the first mobile terminal 410 to record the call audio concurrently with the call connection. When the call connection is established, the processor 370 may display the automatic recording screen 600 illustrated in FIG. 6.

On the other hand, when the first user does not check the check box of the call recording request menu 710 and selects the call acceptance menu 720, the processor 370 may request the first mobile terminal 410 to start the call connection. Furthermore, when the call connection is established, the processor 370 may display a recording request screen 800 illustrated in FIG. 8. The recording request screen 800 may include the phone number of the second mobile terminal 420, the name or nickname of the second user, a menu for requesting in-call recording (Start Recording) 810, and a menu for requesting the termination of call recording (Terminate). When the first user determines that recording is necessary while talking to the second user in the hands-free mode and selects the menu 810, the processor 370 may request the first mobile terminal 410 to start call recording from a time point where the menu 810 is selected.

Furthermore, when it is confirmed that the third option for automatically recording only calls via the current vehicle 10 is set as the setting state of the detailed options, the processor 370 may request the first mobile terminal 410 to automatically record when a hands-free call occurs in the vehicle 10. Accordingly, when the first mobile terminal 410 supports the automatic call recording but the automatic call recording function is off, or when the first mobile terminal 410 supports the second recording function, the first mobile terminal 410 may start automatic call recording concurrently with the start of the call when an automatic call recording request by the third option is received.

Meanwhile, when a call is received from the second mobile terminal 420 and a call channel is connected in the hands-free mode, the processor 370 may be configured to generate and display the call information screen 700 as illustrated in FIG. 7 before the call connection is established when the first mobile terminal 410 supports the second recording function (that is, supports recording but does not support automatic call recording). When the first user checks the check box of the pre-call recording request menu 710 and selects the call acceptance menu 720 on the call information screen 700, the processor 370 may request the first mobile terminal 410 to record the call audio concurrently with the call connection. Furthermore, when the call connection is established, the processor 370 may display the automatic recording screen 600 illustrated in FIG. 6.

On the other hand, when the first user does not check the check box of the call recording request menu 710 and selects the call acceptance menu 720, the processor 370 may request the first mobile terminal 410 to start the call connection. Furthermore, when the call connection is established, the processor 370 may display the recording request screen 800 as illustrated in FIG. 8, and may request the first mobile terminal 410 to record the call audio that is subsequently transmitted and received when the menu 810 is selected during the call.

Furthermore, when call recording is completed, the processor 370 may be configured to generate additional information (hereinafter referred to as “recording additional information”) about the call recording file recorded in hands-free mode and process the recording additional information to be transmitted to the first mobile terminal 410. The recording additional information may include attribute information about the call recording, such as the file name, the recording time, the recording duration, or the recording location of the call recording file (the nickname of the vehicle 10). Since the first mobile terminal 410 records calls and generates call recording files using a native application provided by default when the first mobile terminal 410 is shipped, without installing a separate application in the hands-free mode, the recording additional information is to distinguish between files recorded during general calls and files recorded during hands-free calls.

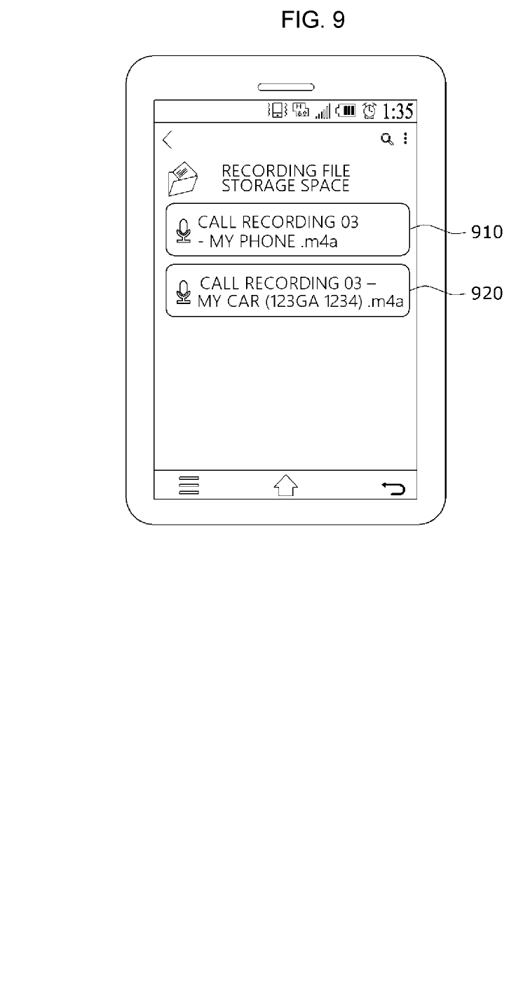

FIG. 9 is an exemplary diagram showing file names of call recording files stored in the first mobile terminal 410.

Referring to FIG. 9, a file name 910 of a call recording file generated when the first mobile terminal 410 makes a general call is different from a file name 920 of a call recording file generated when making a call in the hands-free mode. For example, since the file name 920 includes identification information (123GA 1234) about the vehicle 10, the first user may recognize that the file is a file generated from the call via the vehicle 10 from the file name 920. Furthermore, for example, the file name 910 may be generated by the first mobile terminal 410, and the file name 920 may be generated by the processor 370.

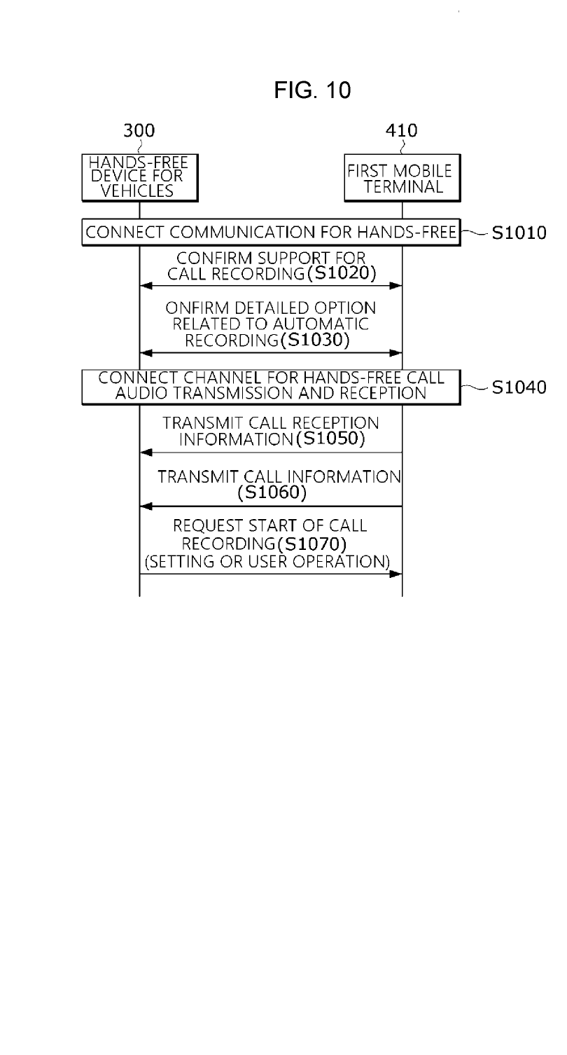

Hereinafter, a method for controlling a hands-free device 300 for vehicles according to various exemplary embodiments of the present disclosure will be briefly described with reference to FIGS. 10 to 17.

FIG. 10 is a flowchart illustrating the operations of the hands-free device 300 and the first mobile terminal 410 when the hands-free device 300 according to various exemplary embodiments of the present disclosure receives a call.

Referring to FIG. 10, when a communication connection between the hands-free device 300 and the first mobile terminal 410 is completed and a communication connection by short-range communication (e.g., Bluetooth) is completed (S1010), the device 300 may confirm whether the first mobile terminal 410 supports a call recording function by querying the first mobile terminal 410 (S1020).

As a result of the confirmation, when it is confirmed that the first mobile terminal 410 provides the first recording function, the device 300 may query and confirm a setting state of detailed options for the first recording function (that is, for automatic call recording), and store a result of the confirmation (S1030).

When a call is received from a second mobile terminal 420, the first mobile terminal 410 may notify the device 300 of the reception of the call and connect a call channel for transmitting and receiving call audio (S1040).

When the call channel connection is completed, the device 300 may receive call reception information from the first mobile terminal 410 (S1050) and receive and display call information (S1060). The call reception information includes information indicating that the call is being received or is waiting to be received. The call information includes the phone number of a caller and the caller’s name, and may be, for example, the screen 500 or 700 illustrated in FIG. 5 or FIG. 7.

When the first user accepts the call, the device 300 may request the first mobile terminal 410 to record the call, either automatically or at a request from the first user (S1070). This allows the phone call received from the second mobile terminal 420 and automatic call recording to start. For example, in operation S1070, the device 300 may confirm the setting state of the detailed options by querying the first mobile terminal 410, and based on the setting state of the detailed options, determine whether to request the first mobile terminal 410 to automatically record the call audio of the first and second users.

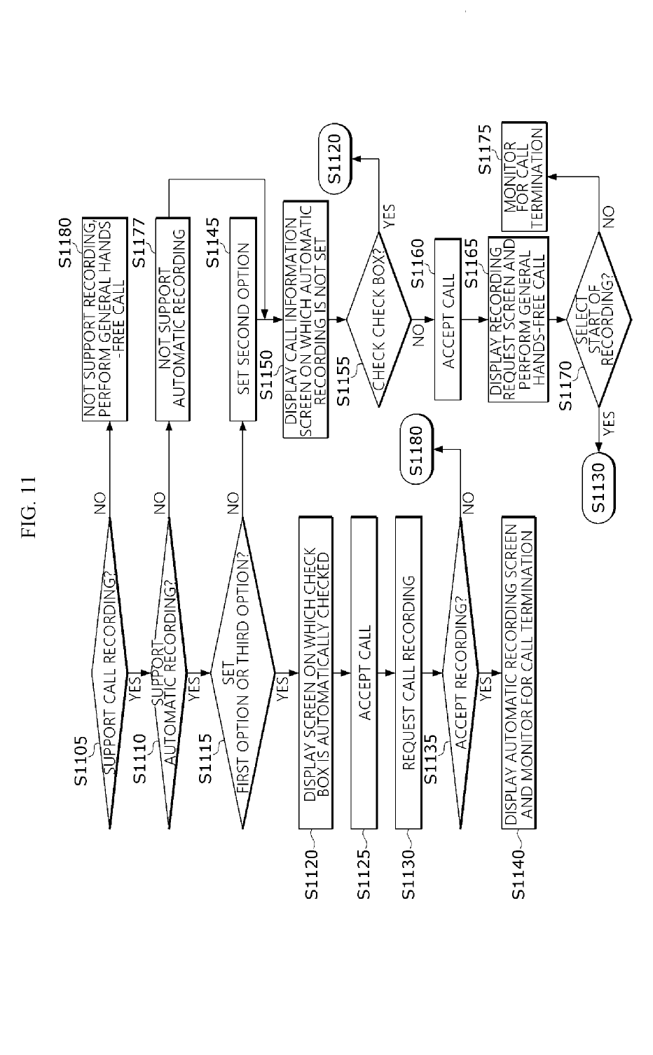

FIG. 11 is a flowchart illustrating operation S1070 illustrated in FIG. 10 in detail when the hands-free device 300 according to various exemplary embodiments of the present disclosure receives a call.

Referring to FIG. 11, the device 300 may confirm whether the first mobile terminal 410 supports the call recording function by querying the first mobile terminal 410 (S1105).

When it is confirmed that the first mobile terminal 410 supports the first recording function, that is, the first function that supports recording and supports automatic call recording (YES in S1105 and YES in S1110), the device 300 may confirm a setting state of detailed options for automatic call recording by querying the first mobile terminal 410 (S1115).

When it is confirmed that the first option or the third option is set (YES in S1115), the device 300 may be configured to generate the call information screen 500 as illustrated in FIG. 5 and display the call information screen on the display unit 340 before the call connection is established (S1120). In operation S1120, the device 300 automatically checks the check box of the pre-call recording request menu 510 on the call information screen 500, thereby allowing the first user to recognize that the current call is automatically recorded.

When the first user selects the call acceptance menu 520 (S1125), the device 300 may switch to a call state and request the first mobile terminal 410 to perform automatic call recording (S1130). That is, the device 300 may request the first mobile terminal 410 to perform automatic recording when a call channel is connected (or when the call starts).

When the first mobile terminal 410 accepts call recording (YES in S1135), the device 300 may be configured to generate and display the automatic recording screen 600 as illustrated in FIG. 6 while making a hands-free call with the second mobile terminal 420, and monitor for call termination (S1140).

Meanwhile, when it is confirmed that the second option is set in operation S1115 (S1145), the device 300 may be configured to generate and display the call information screen 700 in which automatic recording is not set before the call connection is established (S1150).

The device 300 may proceed to operation S1120 and operate when the first user checks the check box 710 on the call information screen 700 (YES in S1155).

On the other hand, when the first user does not check the check box 710 on the call information screen 700 (NO in S1155) and selects the call acceptance menu 720 (S1160), the device 300 may make a general hands-free call after the call is connected to the first mobile terminal 410 (S1165). In operation S1165, the device 300 may display the recording request screen 8B0.

When the first user selects the recording request menu 810 on the recording request screen 800 during the call (YES in S1170), the device 300 may proceed to operation S1130 and operate.

On the other hand, when the recording request menu 810 is not selected in S1165, the device 300 may monitor for call termination in a general hands-free call state (S1175).

Furthermore, as a result of the confirmation in operation S1110, when it is confirmed that the first mobile terminal 410 supports the second recording function (S1177), the device 300 may proceed to operation S1150 and operate.

Furthermore, as the result of the confirmation in operation S1105, when it is confirmed that the first mobile terminal 410 does not support the call recording function (NO in S1105), the device 300 performs a general hands-free call (S1180).

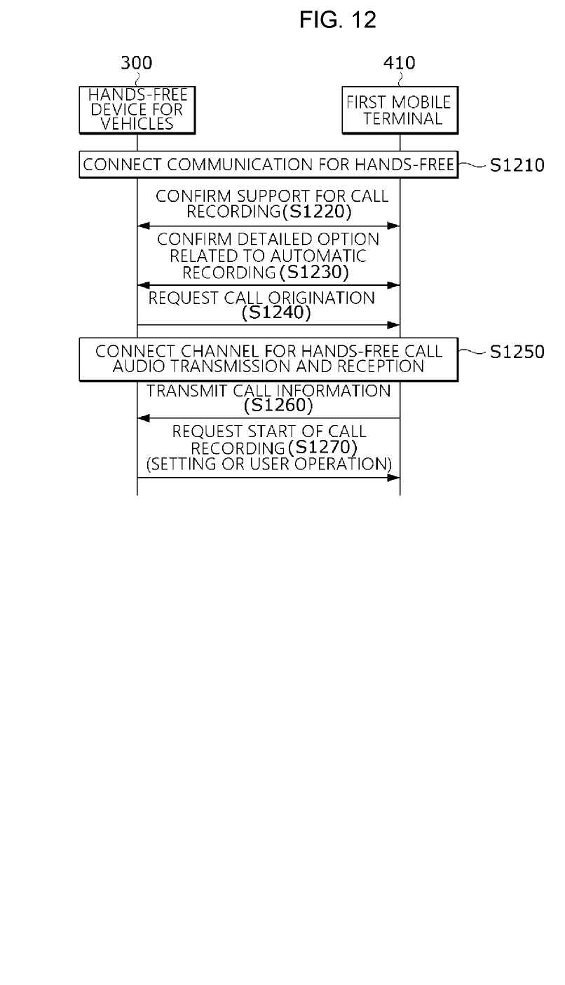

FIG. 12 is a flowchart illustrating the operations of the hands-free device 300 and the first mobile terminal 410 when the hands-free device 300 according to various exemplary embodiments of the present disclosure originates a call.

Referring to FIG. 12, when a communication connection between the hands-free device 300 and the first mobile terminal 410 is completed (S1210), the device 300 may confirm whether the first mobile terminal 410 supports a call recording function by querying the first mobile terminal 410 (S1220).

When it is confirmed that the first mobile terminal 410 provides the first recording function, the device 300 may query and confirm a setting state of detailed options for the first recording function, and store a result of the confirmation (S1230).

When a call origination request is received from the hands-free device 300 (S1240), the first mobile terminal 410 may notify the second mobile terminal 420 of the call origination and connect a call channel for transmitting and receiving call audio (S1250).

When the call channel connection is completed, the device 300 transmits call information to the first mobile terminal 410 (S1260). The call information may include the phone number and caller name of the first mobile terminal 410.

When the second user accepts the call, the device 300 may automatically or manually request the first mobile terminal 410 to start call recording (S1270). This allows recording of the phone call requested from the hands-free device 300 to be performed.

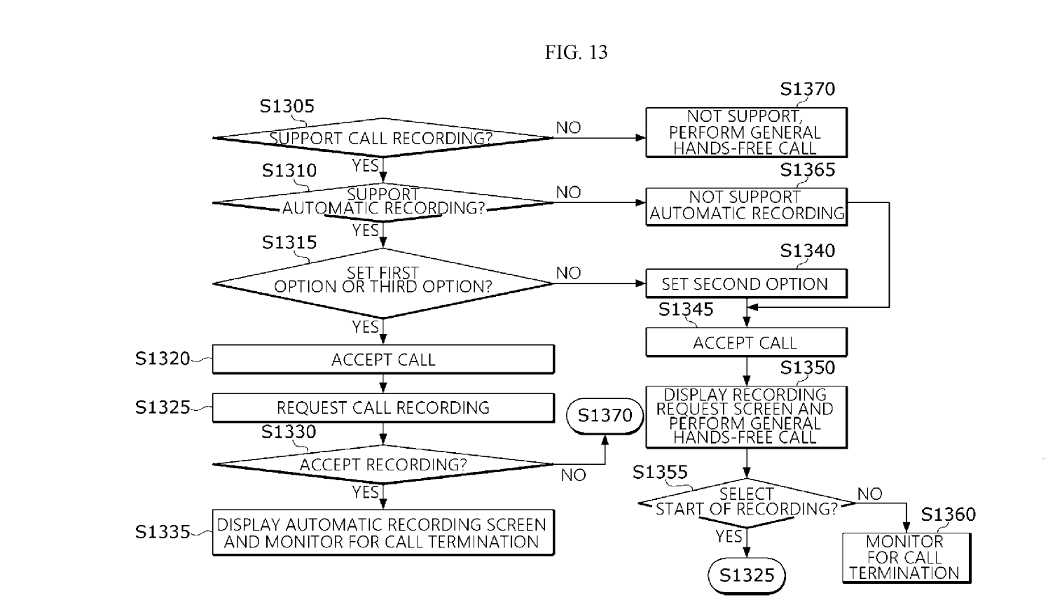

FIG. 13 is a flowchart illustrating operation S1270 illustrated in FIG. 12 in detail when the hands-free device 300 according to various exemplary embodiments of the present disclosure originates a call.

Referring to FIG. 13, the device 300 may confirm whether the first mobile terminal 410 supports the call recording function by querying the first mobile terminal 410 (S1305).

When it is confirmed that the first mobile terminal 410 supports the first recording function (YES in S1305 and YES in 1310), the device 300 may confirm a setting state of detailed options for automatic call recording by querying the first mobile terminal 410 (S1315).

When it is confirmed that the first option or the third option is set (YES in S1315), the device 300 may be configured to generate and display the call information screen 500, and when the first user selects the call acceptance menu 520 (S1320), the device 300 may switch to a call state and request the first mobile terminal 410 to perform automatic call recording (S1325).

When the first mobile terminal 410 accepts call recording (YES in S1330), the device 300 may be configured to generate and display the automatic recording screen 600 while making a hands-free call with the second mobile terminal 420, and monitor for call termination (S1335).

Meanwhile, after it is confirmed that the second option is set in operation S1315 (S1340), when a call acceptance is received from the second mobile terminal 420 (S1345), the recording request screen 800 may be displayed and a general hands-free call may proceed (S1350).

When the first user selects the recording request menu 810 on the recording request screen 800 during the call (YES in S1355), the device 300 may proceed to operation S1325 and operate.

On the other hand, when the recording request menu 810 is not selected, the device 300 may monitor for call termination in a general hands-free call state (S1360).

Furthermore, as a result of the confirmation in operation S1310, when it is confirmed that the first mobile terminal 410 supports the second recording function (S1365), the device 300 may proceed to operation S1345 and operate.

Furthermore, as the result of the confirmation in operation S1305, when it is confirmed that the first mobile terminal 410 does not support the call recording function (NO in S1305), the device 300 performs a general hands-free call (S1370).

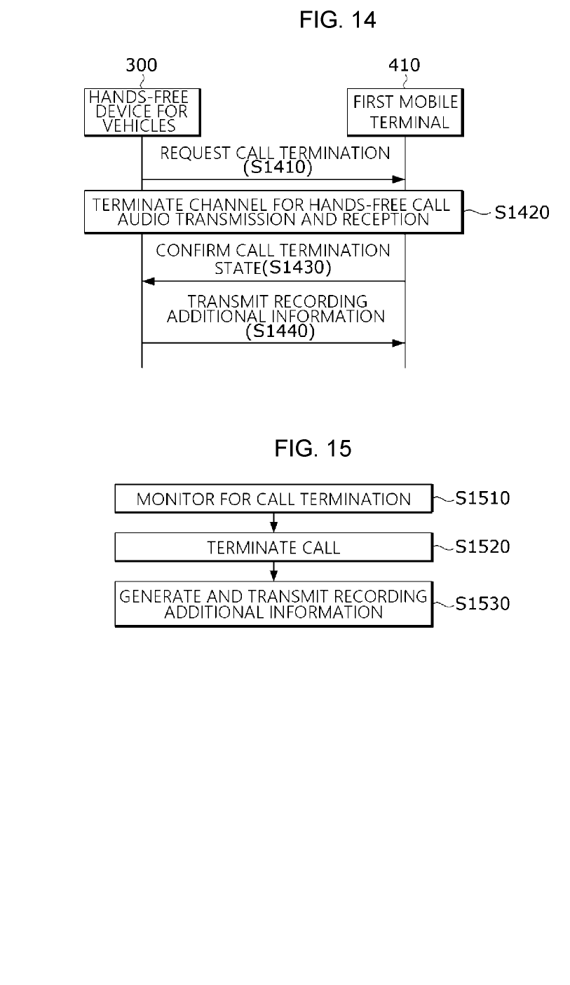

FIG. 14 is a flowchart illustrating the operations of the hands-free device 300 and the first mobile terminal 410 when a call is terminated according to various exemplary embodiments of the present disclosure.

Referring to FIG. 14, when the hands-free device 300 requests call termination (S1410), the device 300 and the first mobile terminal 410 may terminate the channel connected for hands-free call audio transmission and reception (S1420).

The first mobile terminal 410 may report to the device 300 that the call termination has been normally completed (S1430).

The device 300 may be configured to generate recording additional information and transmit the recording additional information to the first mobile terminal 410 (S1440). The recording additional information may include at least one of the file name, the recording time, and the recording duration recorded of a call recording file which is automatically recorded in the hands-free mode.

FIG. 15 is a flowchart illustrating the operation of the hands-free device 300 of FIG. 14.

Referring to FIG. 15, the device 300 monitors for termination of a call with a second mobile terminal 420 (S1510).

When the call is terminated (S1520), the device 300 generates recording additional information and transmits the recording additional information to the first mobile terminal 410 (S1530). Operation S1520 may be configured to determine that the call is terminated, for example, when the first user requests termination of the call by operating the user input unit 330 or when a signal indicating that the call is terminated is received from the second mobile terminal 420.

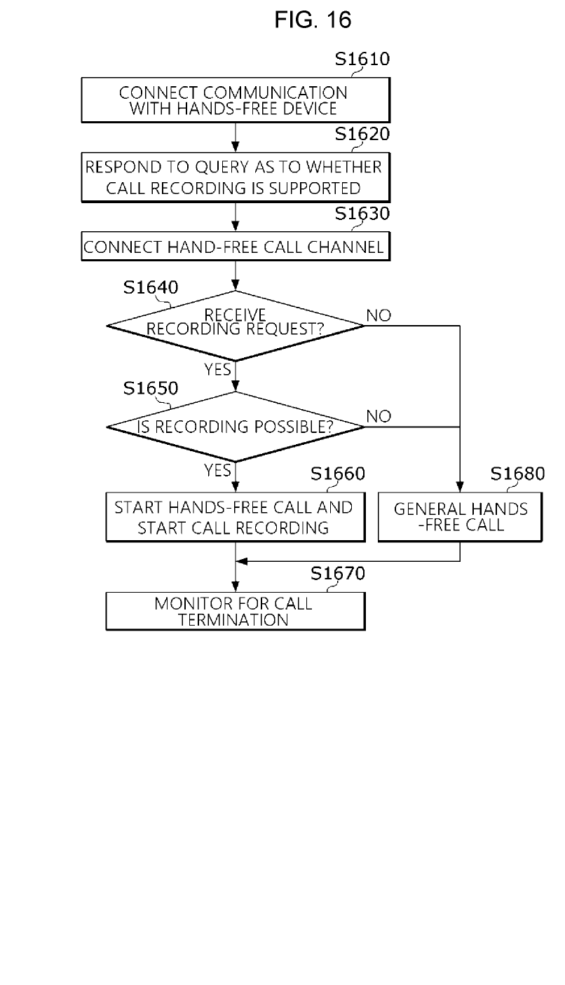

FIG. 16 is a flowchart illustrating an operation of recording a call when the first mobile terminal 410 operates in the hands-free mode according to various exemplary embodiments of the present disclosure.

Referring to FIG. 16, the first mobile terminal 410 is communicably connected to the hands-free device 300 (S1610).

When the first mobile terminal 410 receives a query as to whether call recording is supported from the device 300, the first mobile terminal 410 responds accordingly (S1620). The first mobile terminal 410 may respond to the query by indicating that the first mobile terminal 410 supports recording and also supports automatic recording (the first recording function), or that the first mobile terminal 410 supports recording but does not support automatic recording (the second recording function), or that the first mobile terminal 410 does not support recording.

When a call recording request is received from the device 300 after a channel for the call is connected in the hands-free mode (S1630 and YES in S1640), the first mobile terminal 410 is configured to determine whether recording is possible (S1650).

When recording is possible (YES in S1650), the first mobile terminal 410 notifies the device 300 that recording is accepted and may start recording the call concurrently with the hands-free call (S1660).

The first mobile terminal 410 monitors for call termination concurrently with the call (S1670).

Meanwhile, when the recording request is not received in operation S1640 (NO in S1640) or recording is not possible (NO in S1650), the first mobile terminal 410 makes a general hands-free call (S1680).

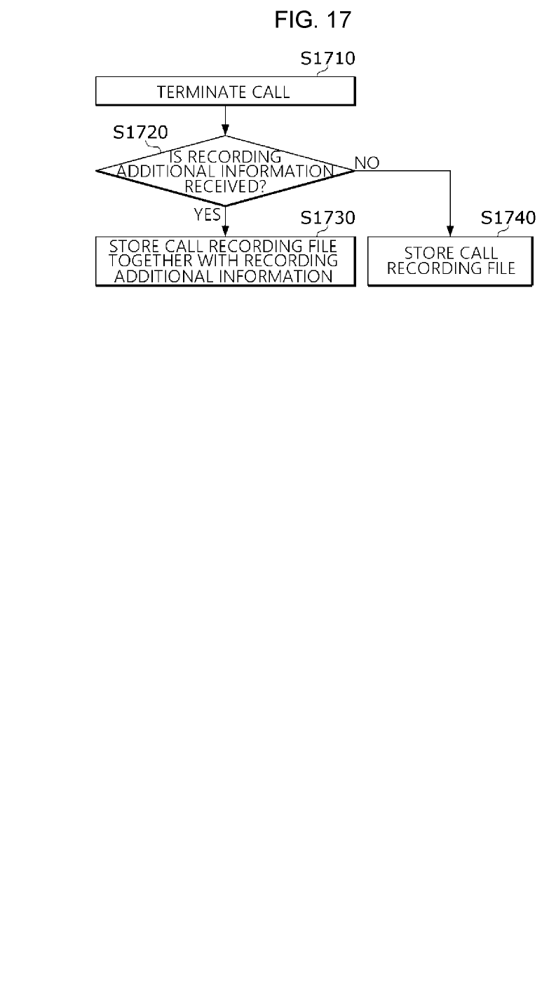

FIG. 17 is a flowchart illustrating the operation of terminating a call when the first mobile terminal 410 operates in the hands-free mode according to various exemplary embodiments of the present disclosure.

Referring to FIG. 17, the first mobile terminal 410 generates a call recording file when a hands-free call is terminated (S1710).

When the first mobile terminal 410 receives recording additional information from the device 300 within a certain time after the call is terminated (YES in S1720), the first mobile terminal 410 stores the recording additional information and the call recording file (S1730).

On the other hand, when the recording additional information is not received (NO in S1720), the first mobile terminal 410 adds a temporary file name to the call recording file and stores the resulting call recording file (S1740).

The operations of the method or algorithm described in relation to the exemplary embodiments disclosed in the present specification may be implemented directly in hardware, a software module, or a combination of the two. The software module may reside in a storage medium (that is, a memory) such as a random-access memory (RAM), a flash memory, a read-only memory (ROM), an erasable programmable read-only memory (EPROM), an electrically erasable programmable read-only memory (EEPROM), a register, a hard disk, a removable disk, or a compact disc (CD)-ROM. An exemplary storage medium may be coupled to the processor, and the processor may read information from, and write information to, the storage medium. Alternatively, the storage medium may be integral to the processor. The processor and the storage medium may reside within an application-specific integrated circuit (ASIC). The ASIC may reside within the user terminal. Alternatively, the processor and the storage medium may reside as separate components within the user terminal.

According to an exemplary embodiment of the present disclosure, the method of object recognition based on sensor fusion to improve the robustness of object recognition through various types of sensor fusion and the vehicle for implementing the same can be provided.

Effects which can be achieved by the present disclosure are not limited to the above-described effects. That is, other objects that are not described may be obviously understood by those skilled in the art to which the present disclosure pertains from the following description.

While the exemplary methods of the present disclosure described above are represented as a series of operations for clarity of description, it is not intended to limit the order in which the steps are performed, and the steps may be performed simultaneously or in different order as necessary. To implement the method according to an exemplary embodiment of the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

Furthermore, various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

What is claimed is:

1. A hands-free device for vehicles, the hands-free device comprising:
a communication unit disposed in a vehicle and communicating with a first mobile terminal; and
a processor requesting the first mobile terminal to record call audio of a user during a call in a hands-free mode based on whether the first mobile terminal supports automatic call recording.

2. The hands-free device of claim 1, wherein the processor:
based on that a connection for hands-free communication with the first mobile terminal is completed,
confirms whether the first mobile terminal supports call recording;
confirms a setting state of detailed options for the automatic call recording based on that a result of the confirmation indicates that the first mobile terminal supports the automatic call recording; and
determines whether to request the first mobile terminal to automatically record the call audio of the user based on the setting state of the detailed options.

3. The hands-free device of claim 2, wherein, based on that a call channel is connected in the hands-free mode, the processor requests the first mobile terminal to perform the automatic call recording based on a first option for automatically recording all calls is set as the setting state of the detailed options.

4. The hands-free device of claim 2, wherein, based on that a call is received from a second mobile terminal and a call channel is connected in the hands-free mode, the processor displays a first user interface (UI) screen including call reception information related to the second mobile terminal, a call acceptance menu, and a menu for requesting call recording based on that the call is accepted on a display unit, based on a second option for deactivating automatic recording of all calls is set as the setting state of the detailed options.

5. The hands-free device of claim 4, wherein, based on that call acceptance and call recording are requested by the user through the first UI screen, the processor requests the first mobile terminal to start the call recording.

6. The hands-free device of claim 2, wherein, based on that a call channel is connected in the hands-free mode, the processor displays a second UI screen including a menu for requesting in-call recording based on a second option for deactivating automatic recording of all calls is set as the setting state of the detailed options on a display unit.

7. The hands-free device of claim 6, wherein, based on that recording is requested by the user during a call through the second UI screen, the processor requests the first mobile terminal to start call recording.

8. The hands-free device of claim 2, wherein, based on that a call channel is connected in the hands-free mode, the processor requests the first mobile terminal to perform the automatic call recording based on that it is confirmed that a third option for automatically recording only calls via a current vehicle is set as the setting state of the detailed options, and
based on that the first mobile terminal supports the automatic call recording but an automatic call recording function is off, the first mobile terminal initiates the automatic call recording based on the automatic call recording request is received.

9. The hands-free device of claim 2, wherein, based on that a call is received from a second mobile terminal and a call channel is connected in the hands-free mode, the processor displays a first UI screen including call reception information related to the second mobile terminal, a call acceptance menu, and a menu for requesting call recording based on that a call is accepted on a display unit, based on that the first mobile terminal supports recording but does not support the automatic call recording.

10. The hands-free device of claim 9, wherein, based on that call acceptance and call recording are requested by the user through the first UI screen, the processor requests the first mobile terminal to start the call recording.

11. A method for controlling a hands-free device for vehicles including one or more memories and at least one processor, the method comprising:
connecting the hands-free device to a first mobile terminal to enable wireless communication and switching the hands-free device to a hands-free mode; and
requesting the first mobile terminal to record call audio of a user during a call in the hands-free mode based on whether the first mobile terminal supports automatic call recording.

12. The method of claim 11, further comprising:
after the switching,
confirming whether the first mobile terminal supports call recording; and
confirming a setting state of detailed options for the automatic call recording based on that a result of the confirming indicates that the first mobile terminal supports the automatic call recording,
wherein in the operation of requesting the first mobile terminal, a determination is made of as to whether to request the first mobile terminal to automatically record the call audio of the user based on the confirmed setting state of the detailed options.

13. The method of claim 12, wherein in the operation of requesting the first mobile terminal, based on that a call channel is connected in the hands-free mode, the first mobile terminal is requested to perform the automatic call recording based on it is confirmed that a first option for automatically recording all calls is set as the setting state of the detailed options.

14. The method of claim 12, wherein in the operation of requesting the first mobile terminal, based on that a call is received from a second mobile terminal and a call channel is connected in the hands-free mode, a first UI screen including call reception information related to the second mobile terminal, a call acceptance menu, and a menu for requesting call recording based on that the call is accepted is displayed, based on a second option for deactivating automatic recording of all calls is set as the setting state of the detailed options.

15. The method of claim 14, wherein in the operation of requesting the first mobile terminal, based on that call acceptance and call recording are requested by the user through the first UI screen, the first mobile terminal is requested to start the call recording.

16. The method of claim 12, wherein in the operation of requesting the first mobile terminal, based on that a call channel is connected in the hands-free mode, a second UI screen including a menu for requesting in-call recording is displayed based on a second option for deactivating automatic recording of all calls is set as the setting state of the detailed options.

17. The method of claim 16, wherein in the operation of requesting the first mobile terminal, based on that recording is requested by the user during the call through the second UI screen, the first mobile terminal is requested to start call recording.

18. The method of claim 12, wherein in the operation of requesting the first mobile terminal, based on that a call channel is connected in the hands-free mode, the first mobile terminal is requested to perform the automatic call recording based on that it is confirmed that a third option for automatically recording only calls via a current vehicle is set as the setting state of the detailed options, and
based on that the first mobile terminal supports the automatic call recording but an automatic call recording function is off, the first mobile terminal initiates the automatic call recording based on the automatic call recording request is received.

19. The method of claim 12, wherein in the operation of requesting the first mobile terminal, based on that a call is received from a second mobile terminal and a call channel is connected in the hands-free mode, a first UI screen including call reception information related to the second mobile terminal, a call acceptance menu, and a menu for requesting call recording based on that a call is accepted is displayed on a display unit, based on that the first mobile terminal supports recording but does not support the automatic call recording.

20. The method of claim 19, wherein in the operation of requesting the first mobile terminal, based on that call acceptance and call recording are requested by the user through the first UI screen, the first mobile terminal is requested to start call recording.
